(19) United States
(12) Patent Application Publication
(10) Pub. No.: US 2023/0217403 A1
(43) Pub. Date: Jul. 6, 2023

(54) DYNAMIC UPDATE OF POSITIONING REFERENCE SIGNALS BASED ON USER EQUIPMENT LOCATION UPDATES

(71) Applicant: NOKIA TECHNOLOGIES OY, Espoo (FI)

(72) Inventors: Timo Koskela, Oulu (FI); Diomidis Michalopoulos, Munich (DE); Juha Pekka Karjalainen, Oulu (FI)

(21) Appl. No.: 17/998,283

(22) PCT Filed: May 15, 2020
(86) PCT No.: PCT/EP2020/063585

§ 371 Date: Nov. 9, 2022

(51) Int. Cl. H04W 64/00; H04W 24/10; H04L 5/00

(52) U.S. Cl. CPC H04W 64/00; H04L 5/0051; H04W 24/10

(57) ABSTRACT

A method, apparatus, and a computer-readable storage medium are provided for dynamic updating of PRSs. In an example implementation, the method may include a user equipment receiving continuous positioning configuration, wherein the continuous positioning configuration comprises a periodic reporting configuration and/or an event-based reporting configuration. The method may further include performing assistance measurements based at least on the continuous positioning configuration and transmitting a measurement report to a network entity, the measurement report based at least on the assistance measurements. In another example implementation, the method may include a gNB receiving one or more updated positioning reference signal resources from the location server and transmitting an updated positioning reference signal to a user equipment, the updated positioning reference signal transmitted using the one or more updated positioning reference signal resources.

### TECHNICAL FIELD

This description relates to wireless communications, and in particular, positioning reference signals.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP’s Long Term Evolution (LTE) upgrade path for mobile networks. In LTE, base stations or access points (APs), which are referred to as enhanced Node AP or Evolved Node B (eNBs), provide wireless access within a coverage area or cell. In LTE, mobile devices, or mobile stations are referred to as user equipments (UE). LTE has included a number of improvements or developments.

5G New Radio (NR) development is part of a continued mobile broadband evolution process to meet the requirements of 5G, similar to earlier evolution of 3G & 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT), and may offer new types of mission-critical services. Ultra-reliable and low-latency communications (URLLC) devices may require high reliability and very low latency.

### SUMMARY

Various example implementations are described and/or illustrated. The details of one or more examples of implementations are set forth in the accompanying drawings and the description below. Other features will be apparent from the description and drawings, and from the claims.

A method, apparatus, and a computer-readable storage medium are provided for dynamic updating of PRSs. In an example implementation, the method may include a user equipment receiving continuous positioning configuration, wherein the continuous positioning configuration comprises a periodic reporting configuration and/or an event-based reporting configuration. The method may further include performing assistance measurements based at least on the continuous positioning configuration and transmitting a measurement report to a network entity, the measurement report based at least on the assistance measurements.

In another example implementation, the method may include a gNB receiving one or more updated positioning reference signal resources from the location server and transmitting an updated positioning reference signal to a user equipment, the updated positioning reference signal transmitted using the one or more updated positioning reference signal resources.

### BRIEF DESCRIPTION OF THE DRAWINGS

FIG. 1 is a block diagram of a wireless network according to an example implementation.

FIGS. 2A-2B illustrate on-demand PRS transmissions, according to example implementations.

FIGS. 3A-3C illustrate dynamic updating of on-demand PRS transmissions, according to example implementations.

FIG. 4 is a flow chart illustrating on-demand PRS transmissions, according to an example implementation.

FIG. 5 is a flow chart illustrating on-demand PRS transmissions, according to an additional example implementation.

FIG. 6 is a block diagram of a node or wireless station (e.g., base station/access point or mobile station/user device/UE), according to an example implementation.

### DETAILED DESCRIPTION

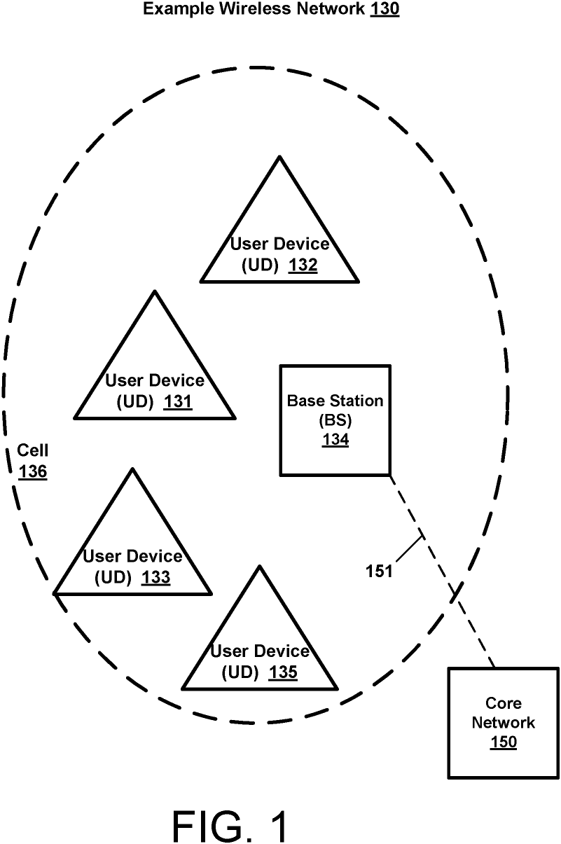

FIG. 1 is a block diagram of a wireless network 130 according to an example implementation. In the wireless network 130 of FIG. 1, user devices (UDs) 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a next-generation Node B (gNB) or a network node. At least part of the functionalities of an access point (AP), base station (BS), (e)Node B (eNB), or gNB may also be carried out by any node, server or host which may be operably coupled to a transceiver, such as a remote radio head. BS (or AP) 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples, or any other wireless device. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

In addition, by way of illustrative example, the various example implementations or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC).

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC or machine to machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing up to e.g., 1 ms U-Plane (user/data plane) latency connectivity with 1-1e-5 reliability, by way of an illustrative example. Thus, for example, URLLC user devices/UEs may require a significantly lower block error rate than other types of user devices/UEs as well as low latency. Thus, for example, a URLLC UE (or URLLC application on a UE) may require much shorter latency, as compared to an eMBB UE (or an eMBB application running on a UE).

The various example implementations may be applied to a wide variety of wireless technologies or wireless networks, such as LTE, LTE-A, 5G, IoT, MTC, eMTC, eMBB, URLLC, etc., or any other wireless network or wireless technology. These example networks, technologies or data service types are provided only as illustrative examples.

Multiple Input, Multiple Output (MIMO) may refer to a technique for increasing the capacity of a radio link using multiple transmit and receive antennas to exploit multipath propagation. MIMO may include the use of multiple antennas at the transmitter and/or the receiver. MIMO may include a multi-dimensional approach that transmits and receives two or more unique data streams through one radio channel. For example, MIMO may refer to a technique for sending and receiving more than one data signal simultaneously over the same radio channel by exploiting multipath propagation. According to an illustrative example, multi-user multiple input, multiple output (multi-user MIMIO, or MU-MIMO) enhances MIMO technology by allowing a base station (BS) or other wireless node to simultaneously transmit or receive multiple streams to different user devices or UEs, which may include simultaneously transmitting a first stream to a first UE, and a second stream to a second UE, via a same (or common or shared) set of physical resource blocks (PRBs) (e.g., where each PRB may include a set of time-frequency resources).

Also, a BS may use precoding to transmit data to a UE (based on a precoder matrix or precoder vector for the UE). For example, a UE may receive reference signals or pilot signals, and may determine a quantized version of a DL channel estimate, and then provide the BS with an indication of the quantized DL channel estimate. The BS may determine a precoder matrix based on the quantized channel estimate, where the precoder matrix may be used to focus or direct transmitted signal energy in the best channel direction for the UE. Also, each UE may use a decoder matrix may be determined, e.g., where the UE may receive reference signals from the BS, determine a channel estimate of the DL channel, and then determine a decoder matrix for the DL channel based on the DL channel estimate. For example, a precoder matrix may indicate antenna weights (e.g., an amplitude/gain and phase for each weight) to be applied to an antenna array of a transmitting wireless device. Likewise, a decoder matrix may indicate antenna weights (e.g., an amplitude/gain and phase for each weight) to be applied to an antenna array of a receiving wireless device. This applies to UL as well when a UE is transmitting data to a BS.

For example, according to an example aspect, a receiving wireless user device may determine a precoder matrix using Interference Rejection Combining (IRC) in which the user device may receive reference signals (or other signals) from a number of BSs (e.g., and may measure a signal strength, signal power, or other signal parameter for a signal received from each BS), and may generate a decoder matrix that may suppress or reduce signals from one or more interferers (or interfering cells or BSs), e.g., by providing a null (or very low antenna gain) in the direction of the interfering signal, in order to increase a signal-to interference plus noise ratio (SINR) of a desired signal. In order to reduce the overall interference from a number of different interferers, a receiver may use, for example, a Linear Minimum Mean Square Error Interference Rejection Combining (LMMSE-IRC) receiver to determine a decoding matrix. The IRC receiver and LMMSE-IRC receiver are merely examples, and other types of receivers or techniques may be used to determine a decoder matrix. After the decoder matrix has been determined, the receiving UE/user device may apply antenna weights (e.g., each antenna weight including amplitude and phase) to a plurality of antennas at the receiving UE or device based on the decoder matrix. Similarly, a precoder matrix may include antenna weights that may be applied to antennas of a transmitting wireless device or node. This applies to a receiving BS as well.

In LTE, positioning/location services for static UEs (e.g., UEs with no mobility) is supported, for example, to support emergency services to determine the approximate location of a UE during emergency calls (e.g., E911 calls in North America). But positioning services for mobile UEs (e.g., UEs with mobility) was not supported in LTE due to its low accuracy. For example, in LTE, the accuracy of a UE’s location is in the range of 10 s of meters or 100 s of meters when observed time difference of arrival (OTDOA) method is used and can depend on factors such as measurement quality, relative location, synchronization of participating eNBs, multipath excess delay, etc.

In contrast, positioning services in NR (or 5G) may support mobile UEs (e.g., UEs with mobility). Example use cases may include automotive industry where global navigation satellite system (GNSS) services may be assisted with NR location to provide coverage in tunnels or highly urban areas where satellite coverage may not be sufficient, automated guided vehicles (AGVs) where NR location may be useful in an indoor environment in the absence of satellite coverage, etc.

In addition, in NR, the accuracy may be better (e.g., higher) than the accuracy provided in LTE. For example, the accuracy in NR may be in the range of <1 m (e.g., commercial use cases) or < 0.2 m (e.g., Industrial Internet of Things (IIoT)). Therefore, UEs moving at low speeds, for example, less than 0.5 m/s) may also experience small dislocations which may be seen as mobility from a network perspective and which may not be addressed with existing positioning approaches. Further, in NR, beamforming may be used which may raise new issues related to updating of PRS transmissions via the beams due to UE’s mobility (changing locations).

Therefore, there is a desire and/or need to update PRS transmissions according to changes in UE’s location.

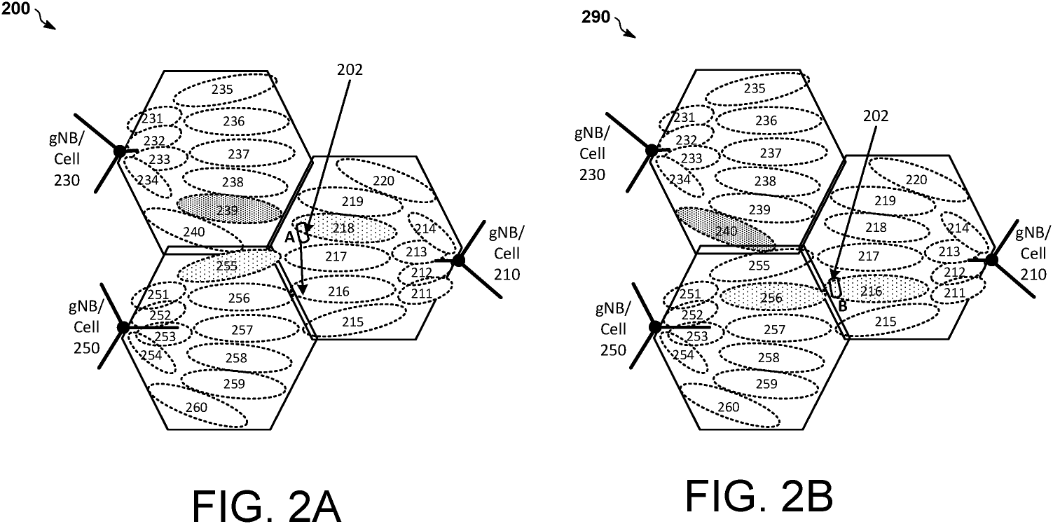

FIG. 2A illustrates on-demand PRS transmissions 200, according to an example implementation. FIG. 2B illustrates on-demand PRS transmissions 290, according to an additional example implementation.

In some implementations, for example, on-demand PRSs may be transmitted only in the direction where there is at least one UE which may receive and process the PRSs for deriving the location of the UE, either at the UE itself or at the network after the measurements are reported to the network. In some implementations, for example, dynamic PRSs may refer to a network providing increased PRS resources, for example, for more frequent measurement opportunities or PRS resources with increased bandwidths, e.g., wider bandwidth to designated areas in case there is a need for stronger reception of PRS signals, for example, for higher accuracy.

In an example implementation, FIG. 2A illustrates a UE (e.g., UE 202) and three gNBs/cells/ transmission reception points (TRPs) (e.g., gNBs 210, 230, and 250). gNB 210 may be a serving gNB and gNBs 230 and 250 may be neighbor gNBs.

As illustrated in FIG. 2A, UE may receive PRSs from gNBs 210, 230, and/or 250. This is just one example implementation. In another example implementation, 210, 230, 250 may be different cells or different TRPs of a cell.

In FIG. 2A, UE 202 may be located at location “A” and may be receiving PRSs from gNBs 210, 230, and 250 via beams (or resources) 218, 239, and 255, respectively. As the UE is a mobile UE (e.g., UE moving), the UE may move from location A shown in FIG. 2A to location B as shown in FIG. 2B. In such a scenario, the beams that were transmitting the PRSs to the UE may not be the best (e.g., strongest) beams and may have to be updated (or changed) based on, for example, the latest location of the UE (e.g., location B as shown in FIG. 2B). In other words, different beams may have to be used to transmit the PRSs to the UE to achieve efficiency of PRS resources and sufficient signal reception at the UE or the beams transmitting the PRSs from the serving and neighboring gNBs may have to be updated according to the latest location of the UE or based on the changes in the radio environment.

In an example implementation, FIG. 2B illustrates UE 202 receiving PRSs (e.g., updated PRSs) from gNBs 210, 230, and 250 via beams 216, 240, and 256, respectively, which may be based on current location of UE 202 as shown in FIG. 2B (e.g., location B).

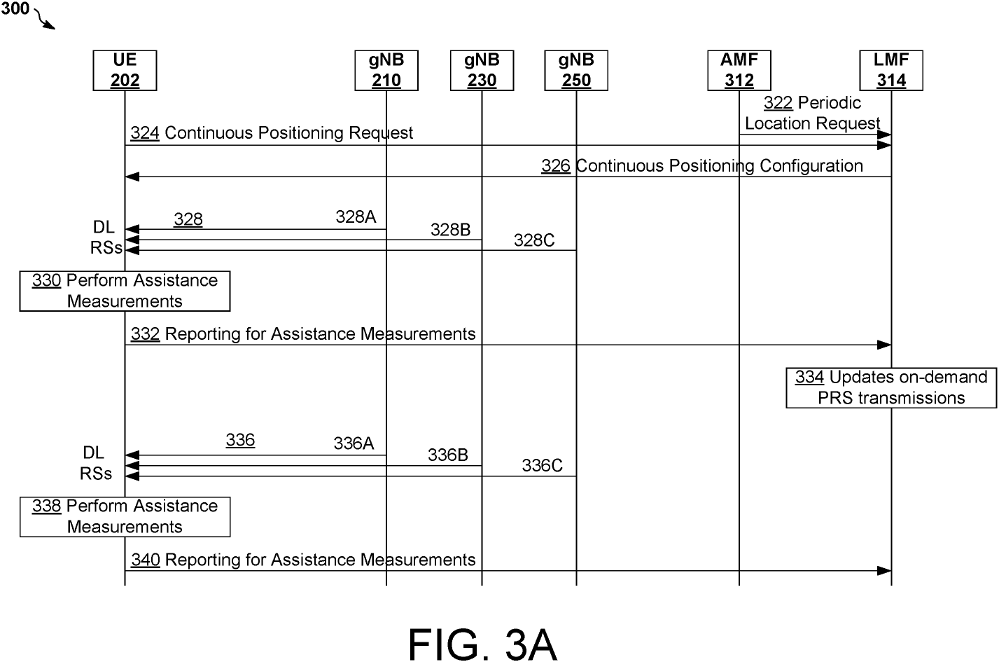

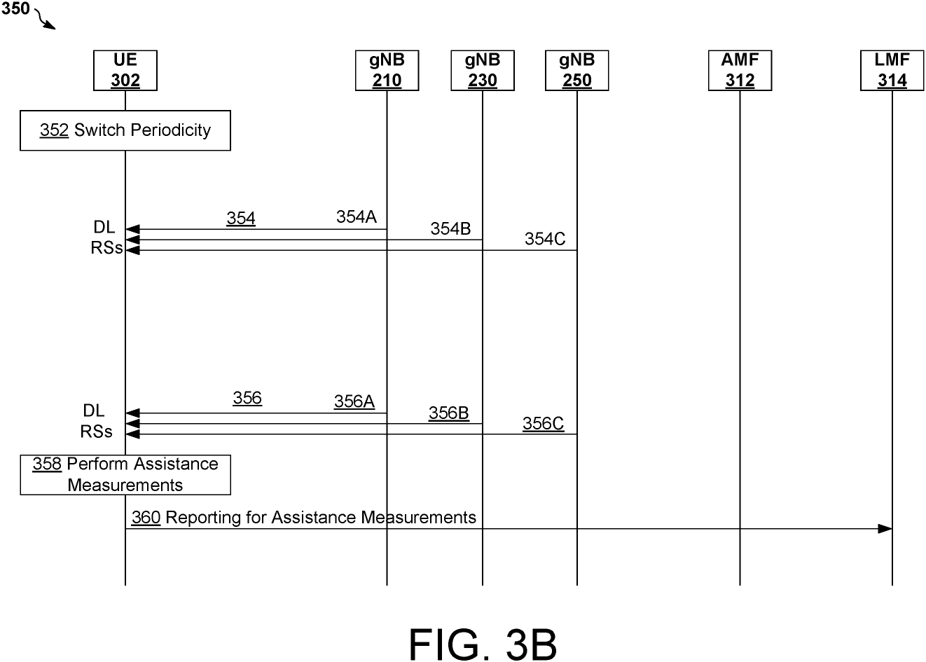

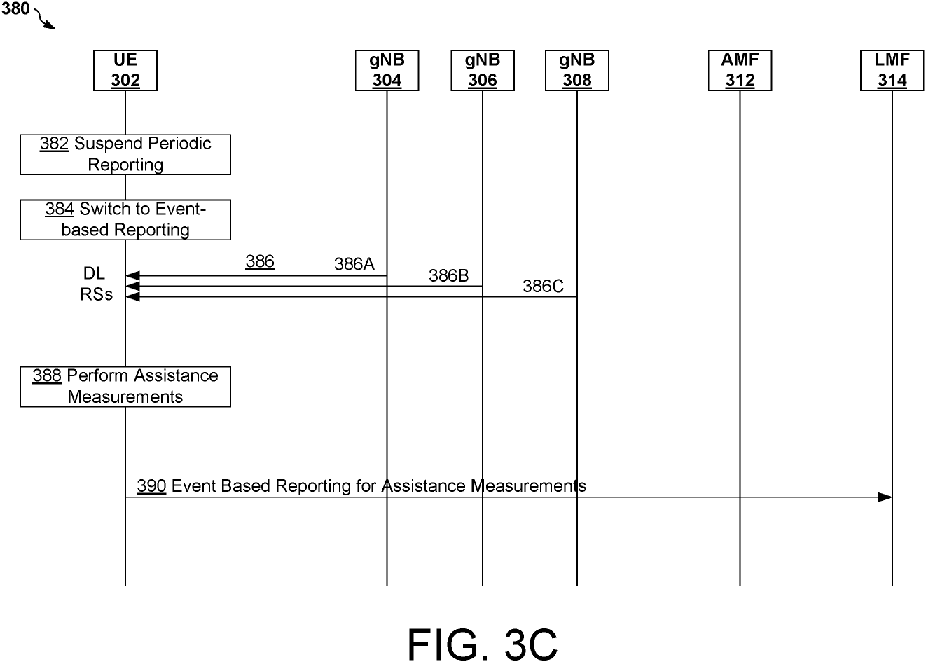

In an example implementation, the present disclosure proposes a mechanism to update the beams used for transmitting PRSs (or update PRS resources) for a UE based on location of the UE which may be based at least on signaling exchange between the UE and the network. In some implementations, for example, the network may include several entities, e.g., a serving gNB (e.g., gNB 210), one or more neighbor gNBs (e.g., gNBs 230 and 250), an access management function (AMF), a location server (e.g., a location management function, LMF), which are further described in detail in FIGS. 3A-3C.

FIG. 3A illustrates dynamic updating of on-demand PRS transmissions 300, according to an example implementation.

In an example implementation, FIG. 3A illustrates a UE, e.g., UE 202, and three gNBs/cells/TRPs, e.g., gNBs 210, 230, and 250. In addition, FIG. 3A illustrates an access management function 312 and a location management function 314. An AMF (also referred to as Core Access and Mobility Management Function) is part of 3GPP architecture and is primarily responsible for registration management, connection management, reachability management, mobility management, and various functions related to security and access management and authorization. An LMF may obtain downlink location measurements or location estimates from the UE, obtain uplink location measurements from a next generation radio access network (NG RAN), obtain non-UE associated assistance data from the NG RAN, and support location determination for the UE.

In some implementations, for example, at 326, UE may receive a continuous positioning configuration from a location server, e.g., location management function 314. In an example implementation, the continuous positioning configuration may include configuration information related to periodic reporting configuration and/or event-based reporting configuration. The periodic reporting configuration may indicate to a UE to periodically perform assistance measurements and report the assistance measurements to the UE. The event-based reporting configuration may indicate to the UE to perform assistance measurements in response to an event received by the UE and report the assistance measurements. That is, the assistance measurements may be reported in response to a trigger (e.g., event) received by a UE.

UE 202 may receive the continuous positioning configuration from LMF 314 in response to the LMF receiving a periodic location request from AMF 312 at 322 or a continuous positioning request from UE 302 at 324. In some implementations, for example, the LMF may send the continuous positioning configuration to the UE when the LMF determines to initiate or switch UE positioning session to mobile or periodic.

In some implementations, for example, at 328, UE 202 may receive downlink reference signals from the gNBs. For example, at 328, the UE may receive downlink reference signals, 328A, 328B, and 328C, from gNBs 210, 230, and 250, respectively, where gNB 210 may be a serving gNB and gNBs 230 and/or 250 may be neighbor gNBs.

In an example implementation, as illustrated in FIG. 2A, the UE may be at location A and receive the DL RSs via beams 218, 239, and 255 from gNBs 210, 230, and 250, respectively, which may be the best (e.g., strongest in terms of quality metric such as RSRP/SINR, etc.) beams from gNBs 210, 230, and 250 at the UE, the shortest beams corresponding to the shortest time of flight (e.g., traverse time of a signal transmitted on a beam or a time of arrival) between the cells (or reference points or transmission points) and UE, or the beams that the UE has reported to the network. The downlink reference signals, in some implementations, may include a non-zero power channel state information-reference signal (NZP CSI-RS), a synchronization signal block (SSB), or a channel state information-reference signal (CSI-RS). In some implementations, for example, the UE may also provide measurements and reporting on PRS signals. The PRS signals may be used as source /reference signals for other/additional PRS signals.

At 330, UE 202 may perform assistance measurements. In some implementations, for example, the assistance measurements may include detected signal quality values, e.g., layer-1 reference signal received power (L1-RSRP) measurements, layer-1 signal-to-interference-plus-noise-ratio (L1-SINR), resource/resource set indices associated with the downlink reference signals, e.g., non-zero power RS, SSB, L3 mobility CSI-RS, or PRS (e.g., PRS-RSRP). In an additional example implementation, measurements may include, additionally or alternatively, time of flight.

At 332, UE 202 may report the assistance measurements. In some implementations, for example, UE may report the assistance measurements to the LMF. In an example implementation, the UE may measure and report the assistance measurements periodically based on, for example, the periodic reporting configuration of the continuous positioning configuration, which may have been received at 326. It should be noted that in any of the implementations (or a combination of the implementations) described herein, the UE may report measurements/assistance measurements to the network. The network may be an LMF (e.g., a local location management function at a radio access network, which may be also referred to as a location management component, LMC) and/or a gNB. In some implementations, for example, the measurement reporting or any signaling between the network and the UE may be carried out using L1, L2 (medium access control, MAC), L3 (radio resource control, RRC), NR/LTE Positioning Protocol (LPP), etc.

In some implementations, for example, the periodic reporting configuration may include one or more periodicities. For example, in an implementation, the periodicities may include X, Y, and Z, where X < Y < Z. A lower periodicity value (e.g., X) may indicate performing and reporting measurements more frequently when compared a higher periodicity value (e.g., Y). In an example implementation, the UE may measure and/o report the assistance measurements at 330 and 332 with a periodicity of X.

In addition, in some implementations, for example, the UE may be configured with a periodicity value specific reporting configuration where the UE may report or may be configured to report assistance measurements using different parameter sets associated with the periodicity value.

In any of the implementations described herein, the on-demand PRS configuration may also be referred as dynamic PRS configuration, UE specific PRS configuration, additional PRS configuration, dedicated PRS configuration, etc.

At 334, LMF 314 may update the on-demand/dynamic PRS transmissions. In some implementations, for example, the LMF may update on-demand/dynamic PRS transmissions based at least on the assistance measurements report received from the UE. This may include updating the PRS resources (e.g., providing the UE with a new set of PRS resources or providing an update on the (QCL) source reference RS for current PRS resource) to be used for PRS transmissions and notifying the gNBs so that the gNBs may transmit the updated PRSs on the updated beams. In some implementations, for example, when a signal is considered to be a QCL source for another signal and the QCL type (e.g., typeD, spatial RX, etc.) is indicated/configured for the signals, the UE may use same reception assumptions for receiving the signals. For example, for QCL typeD, the UE may assume that it may use the same RX beam for receiving the QCL’d signals. In some implementations, for example, an updated PRS may refer to the network configuring a UE with new/additional PRS resource configuration; an updated beam may refer to the configuring a UE with current PRS resource but indicate the different source beam or reference beam/beams for a PRS resource or resources; and updated resource may refer to the network configuring current PRS resource or a new PRS resource with higher bandwidth/periodicity, etc. In some implementations, the LMF may send messages to the gNBs using NR positioning protocol A (NRPPa) with the updated PRS information.

At 336, in some implementations, for example, UE 202 may receive downlink reference signals (DL RSs), 336A, 336, and 336C, which may include the updated PRSs, via beams 216, 240, and 256 from gNBs 210, 230, and 250, respectively.

In an example implementation, as illustrated in FIG. 2B, the UE may be located at location B (e.g., due to UE mobility) and receive the PRSs via beams 216, 240, and 255 from gNBs 210, 230, and 250, respectively, which may be the best (strongest) beams or the beams UE has reported from gNBs 210, 230, and 250 at the UE.

At 338, UE 202 may perform assistance measurements, similar to the performing assistance measurements at 330.

At 340, UE 202 may report the assistance measurements, similar to the reporting of assistance measurements at 332.

FIG. 3B illustrates dynamic updating of on-demand/dynamic PRS transmissions 350, according to an additional example implementation.

At 352, UE 302 may determine whether to switch periodicity and switch the periodicity accordingly. In some implementations, for example, the UE may be configured with multiple periodicities (e.g., X, Y, and Z), as described above, and may be configured to determine whether the periodicity has to be switched (e.g., changed) based on whether a periodicity switching condition (e.g., to switch from a first periodicity to a second periodicity) is satisfied. In some implementations, the switching of reporting configuration may include switching from a higher periodicity to a lower periodicity, from a lower periodicity to a higher periodicity, or changing the number of beams to be reported (e.g., switching from reporting up to N beams to reporting up to M beams where N<M or N>M).

For example, UE’s radio conditions may change during a positioning session (or when the UE needs continuous positioning, e.g., the UE would need to periodically update/perform measurements to determine its location) from dynamic to non-dynamic or vice versa. A positioning session, which may involve multiple PRS transmissions to the UEs, and may be generally defined as a procedure during which the location of the UE is calculated (e.g., which may involve messaging exchange, measurements, etc.). For example, in a continuous positioning session, multiple PRS updates may take place. A positioning session may end when there is no need to keep positioning on UE or until a new positioning request arrives which may require initiation of a new positioning session.

A UE may experience dynamic radio conditions when the UE moves or rotates, e.g., the UE may detect new beams or that the current beams used for PRS measurements for positioning may not be detected or may not have sufficient quality. In an additional example implementation, for example, in beam-based communications, the UE may experience fast (or relatively fast) degradation of beam quality which may be considered as dynamic radio environment/conditions. In another additional example implementation, when the UE is considered to be relatively stationary the radio conditions may be expected to be static or nearly static so that when the UE performs measurements, the different measurement results may highly correlate. In a scenario, where the UE’s condition changes from dynamic to non-dynamic (and vice versa), e.g. no or little relative movement between the UE and the gNBs and/or rotation of UE, etc.), the network may configure the UE with one or more or multiple periodicities and may further configure the UE with a mechanism to select the reporting periodicity (e.g., selection criteria). In an example implementation, if the same report (e.g., assistance measurements) is reported for a high periodicity value, the UE may switch to lower periodicity value for network optimization, e.g., to save on signaling. For example, if the same report is reported at 332 and 340, UE 202 may switch to a lower periodicity, e.g., Y or Z. This means that the UE may perform and report assistance measurements less frequently to save signaling resources. In some implementations, the lower periodicity may apply for future assistance measurements.

In some implementations, for example, a UE may determine to switch to a different reporting configuration based on any methods described herein, where the different reporting configurations may include changing of one or more of, e.g., reporting periodicity, reporting quantity (e.g., L1-RSRP/L1-SINR), number of reported beams (e.g., UE previously has reported up to N strongest or N shortest beams (e.g. in terms of time of flight), or reported up to N beams and it may report M beams), values, and the UE would switch to different reporting configuration. In an example implementation, the UE may switch to reporting up to M beams when in the previous configuration it reported up to N beams while the periodicity is the same. In an additional example implementation, one more of the parameters may change between the configurations. In any of the methods herein, a UE may be configured to report up to N-highest beam/resource indices according to (configured) measurement quantity (e.g. SSB-RSRP, PRS-RSRP, time of flight since PRS time of departure, etc.) or the UE may be configured to report up to N-beam indices.

At 354, in some implementations, UE 202 may receive downlink reference signals (DL RSs) 354A, 354B, and 354C, which may include PRSs from the gNBs via beams 216, 240, and 256 from gNBs 210, 230, and 250, respectively. It should be noted that UE may skip (e.g., not perform) performing and reporting of assistance measurements as the periodicity has been updated to measure/report less frequently (e.g., periodicity of Y or Z).

At 356, in some implementations, UE 202 may receive, again, downlink reference signals (DL RSs), 356A, 356B, and 356C, which may include PRSs from the gNBs via beams 216, 240, and 256 from gNBs 210, 230, and 250, respectively.

At 358, UE 202 may perform assistance measurements, similar to the performing assistance measurements at 330.

At 360, UE 202 may report the assistance measurements, similar to the reporting of assistance measurements at 332.

FIG. 3C illustrates dynamic updating of on-demand PRS transmissions 380, according to another additional example implementation.

In some implementations, for example, at 382, UE 202 may suspend (or cease) periodic reporting. In an example implementation, the UE may suspend periodic reporting if a condition (e.g., a periodic reporting suspension condition) is satisfied. In some implementations, the periodic reporting suspension condition may be based on the continuous positioning configuration received from the LMF. In an example implementation, if the same report is reported by the UE for a threshold number of times (e.g., N number of times), the UE may suspend (e.g., stop) the periodic reporting.

At 384, the UE may switch to event-based reporting. In some implementations, the UE may switch to event-based reporting if a configuration type switching condition is satisfied. In an example implementation, the configuration type switching condition may be defined in the continuous positioning configuration received the LMF.

In some implementations, for example, at 386, UE 202 may receive downlink reference signals (DL RSs), 386A, 386B, and 386C, which may include PRSs from the gNBs. For example, the UE may receive the PRSs, 386A, 386B, and 386C, from gNBs 210, 230, and 250, respectively, where gNB 210 may be a serving gNB and gNBs 230 and/or 250 may be neighbor gNBs.

In an example implementation, as illustrated in FIG. 2B, the UE may be at location B and receive the downlink reference signals via beams 216, 240, and 256 from gNBs 210, 230, and 250, respectively, which may be the best beams from gNBs 210, 230, and 250 at the UE.

At 388, UE 202 may perform assistance measurements, similar to the performing assistance measurements at 330.

At 390, UE 202 may report the assistance measurements, similar to the reporting of assistance measurements at 332. In some implementations, for example, UE may report the assistance measurements in response to receiving of an event (e.g., a pre-defined event) as described below in detail.

Thus, the PRSs are dynamically updated based on UE location updates while improving signaling efficiency.

In some implementations, the UE may be configured with the periodic reporting configuration and/or event-based reporting configuration and with the conditions when to enable/disable them. In addition, in some implementations, for example, the UE may provide the network information on UE capability, e.g., number of antenna panels, RX sweep information or measurements, e.g., number of RX occasions for full sweep, etc.

In some implementations, for example, the network (e.g., LMF 314) may configure the UE to provide assistance measurements in a periodic manner for updating the PRS configuration. In an example implementation, the UE may be configured to report up to a first number of SSBs (e.g., N1 SSBs) across gNBs or a second number of SSBs (e.g., N2 SSBs) per cell. In other words, the LMF may limit the number of SSBs being reported from the UE for efficiency. In an additional example implementation, the network may configure the UE to report L3 CSI-RS (e.g., CSI-RS for L3 Mobility) or NZP-CSI-RS (e.g., CSI-RS for beam management) measurements. In another additional example implementation, the UE may be configured to report assistance measurements for at least one cell. In an example implementation, the network may have knowledge that a specific cell may be covered by more than one TRPs that may be used as reference points for positioning measurements.

In some implementations, for example, the network may configure the UE to provide assistance measurements on a specific set of gNBs/cells. In an example implementation, the on-demand/dynamic PRS (and/or updates of PRS resources) may be limited to a list/set of gNBs/cells. In an additional example implementation, when the UE performs a reselection or handed over to a different gNB/cell that may not be included in the provided list, the UE may be required to trigger an indication to LMF. In response, the LMF may further configure the UE to not provide assistance measurements, for example, for the case where dynamic PRS configuration may not be supported or is not possible to support.

In some implementations, for example, the network may configure the UE with one or multiple periodicities where the periodicity values may be different. In an example implementation, one periodicity value may be configured as a relative value to another periodicity value or they may be configured separately. Example periodicity values may include a first periodicity value (P1= 1000 ms) and a second periodicity value (P2=4000 ms).

In some implementations, for example, when the UE has reported the same SSBs in “T” consecutive reporting instances (e.g., assistance measurements) using P1 reporting periodicity, the UE may switch to P2 reporting periodicity for subsequent reporting. The value of T may be configured by network and may be counted within in a time window. For example, T reporting instances with same information within a time period. In an additional example implementation, the UE may indicate the periodicity change explicitly in the report, e.g., that the UE may switch from P1 to P2 periodicity after the current report. In an additional example implementation, the UE may be configured to switch to the P2 periodicity for the X-subsequent reporting. after that UE evaluates the periodicity change again.

In some implementations, for example, when determining whether the same information is reported may include one or more of the following (for SSB/CSI-RS/PRS-RS, etc.): UE has not reported any new SSBs in T reporting instances; UE has not performed and reported PRS measurements on new PRS signals; UE has reported same N-SSBs T reporting instances; UE has reported same M- downlink RS (SSBs) that were used for PRS measurements in T reporting instances; UE the reported K-highest SSBs in T reporting instances; ;and UE has reported at least K same SSBs in T reporting instances. It should be noted that the listed examples may be per (e.g., on the basis) assistance measurements report, per report per cell, per report per at least one cell/TRP, per report across set of cells, report across at least 3 cells, report across cells considered for reporting, per report on one or more TRPs, etc. For PRS measurements, the UE may determine the reporting based on the PRS used for reporting the positioning measurements. In an example implementation, if the UE performs more than one measurement and reporting on the same PRS resources, it may determine that same information is reported, and it may switch the reporting configuration (e.g., for assistance measurements). In other words, the UE may change the periodicity, the reporting parameters, or the configuration when it determines or has determined that it reports no new information or reports only partially new information or reports redundant information or reports same information as previously on one or more reporting occasions. In an additional example implementation, the new information may also be determined based on a quantity metric, for example, the UE may determine that up to K-highest reported beams have not changed in consecutive reports or in a number of reports within a window and the UE may determine that same information is reported or determine that it may switch the periodicity.

In some implementations, for example, if the network has configured the UE with one reporting periodicity for PRS assistance measurements, the UE may be configured to cease/suspend reporting when, for example, the UE determines that the UE may report the same information for the N^{th} time (e.g., either in consecutive reports or in a time window), wherein the value of N is configured by the network. In an additional example implementation, if the UE determines that M1-highest reported SSB indexes/PRS indices used for positioning measurement reporting (e.g., based on RSRP values or PRS/SSB/DL-RS time of flight) have not changed or have not changed for any of the reported cells in N latest reporting instances (e.g., consecutive or within a time window), the UE may be configured to cease/suspend reporting. In another additional example implementation, the UE may be configured to cease/suspend/switch periodicity reporting in response to receiving of a cease/suspend/switch periodic reporting message from the network. In some implementations, the network may also provide explicitly the new reporting periodicity value or other parameter relevant for the new configuration (e.g., the number of beams to be reported). In another additional example implementation, the UE may indicate the suspension explicitly in the latest assistance measurement reported to the network. In some implementations, for example, the UE may report, for example, up to N-highest beams in terms of quality/traverse time or the UE may report up to N beams.

In some implementations, for example, upon the UE ceasing/suspending of the periodic reporting, the UE may cease (stop) any reporting operations until the UE receives a new request for reporting of the assistance measurements from the network. In an example implementation, the UE may switch to event-based reporting according to the configuration received from the network.

In some implementations, for example, the UE may use any combination of the above described implementations.

In some implementations, when the UE determines that a reporting event has occurred, which may be related to event-based reporting, the UE may revert back to the previously (originally) configured reporting configuration. For example, the reporting event may be that the reported information has changed compared to the previously reported, the reporting event may be that at least N of the previously reported SSBs have changed, for example, new SSBs may have been detected or the SSB quasi co-location (QCL) sources for PRSs have changed in quality or event may also be PRS RSRP based. In some implementations, for example, the reporting event may comprise determining whether network has configured a PRS with QCL for the specific SSB that the UE has reported.

In some implementations, the network may provide the UE at least one cell or a cell group, a tracking area, or a radio access network (RAN) notification area where the assistance measurements and reporting may be valid. When UE performs cell reselection or is handed over to another cell, in any of the reporting related aspects, the UE may be configured to report per SSB basis, or per SSB set basis. In an example implementation, the UE may indicate network suitable SSB sets that have been preconfigured by network. The UE may be configured to refer the specific SSB sets with a logical index. In an example implementation, the indicating of a preferred set or sets, the UE may indicate the network (e.g. LMF) that it prefers PRS configuration on the indicated SSB or SSBs (or other DL RSs configured for reporting). In an additional example implementation, preferring SSB set may be based on threshold-based reporting, for example, if at least one or N out of M SSBs in a set is above quality threshold such as RSRP, and the UE is allowed to indicate it as “preferred.”

In some implementations, for example, the UE may be configured with a limited set of PRSs that may be associated/QCL’d with already reported QCL source signals which may reduce the amount of time the UE is required to use PRS measurements. In an example implementation, by enabling network to configure dynamic PRSs for the UE in a specific manner to reduce the configuration overhead.

In some implementations, for example, the PRS mobility update may be triggered by layer 1 (L1) beam reporting in case the PRS is transmitted by the serving cell, following the L1 beam management procedure. For example, the L1 of serving gNB may indicate to location server (e.g., LMF) about the received beam management measurements provided by the UE. The location server may indicate to the serving gNB about the new PRS resource, and serving cell/LMF may update the PRS transmission from the newly indicated resource. In some implementations, the serving gNB may update the PRS transmission to the strongest beam (e.g., in terms of RSRP or time of flight or other quantity) or a set of beams (e.g., according to L1 beam management/L3 SSB measurements) and may indicate the update to the location server.

In some implementations, for example, the PRS mobility update/event-based reporting may be triggered by the UE in case it detects a beam that is stronger than the beam or beams providing the PRS. This detection may be performed per cell, per PRS resource, per PRS resource set, or per TRP (or a reference point). This maybe applicable to PRS mobility update with neighboring cells. For example, the UE may indicate to the location server the stronger beam (e.g., in terms of quantity) by a neighboring cell. The location server may update the on-demand PRS transmission of that neighboring cell to the designated beam, e.g., the PRS resource for that UE is updated. In an example implementation, the location server may indicate to the neighbor cell the strongest beam or a set of highest quality beam/beams (e.g., in terms of RSRP and/or time of flight) detected/measured by the UE. The neighbor cell may update the PRS transmission from the previously transmitted beam (e.g., PRS resource) to the newly indicated beam (e.g., PRS resource).

In some implementations, for example, in an event-based reporting, the UE may be configured to report: when it determines that a beam (e.g., downlink RS such as SSB/CSI-RS, etc.) is not currently configured as a source RS for PRS transmission; or when it determines that a beam (e.g., downlink RS such as SSB/CSI-RS) is not currently configured as a source RS for PRS transmission and it has quality above a specific threshold (e.g., RSRP or time of flight); or when it determines that a beam (e.g., downlink RS such as SSB/CSI-RS) is not currently configured as a source RS for PRS transmission and it has a quality higher than the M^{th} source RS/beam that is currently used for PRS transmission. In some implementations, for example, any of the parameters herein may be configured by network.

In some implementations, for example, if the UE route is known, then the network may provide PRS sets for the UE, and the UE may be requested to update which resource set would need to be activated. In other words, the network may suspend other resources while specific set is resumed when the UE moves.

In some implementations, for example, where in case there is no such event-based report, the network implicitly uses the previous report as continuously valid.

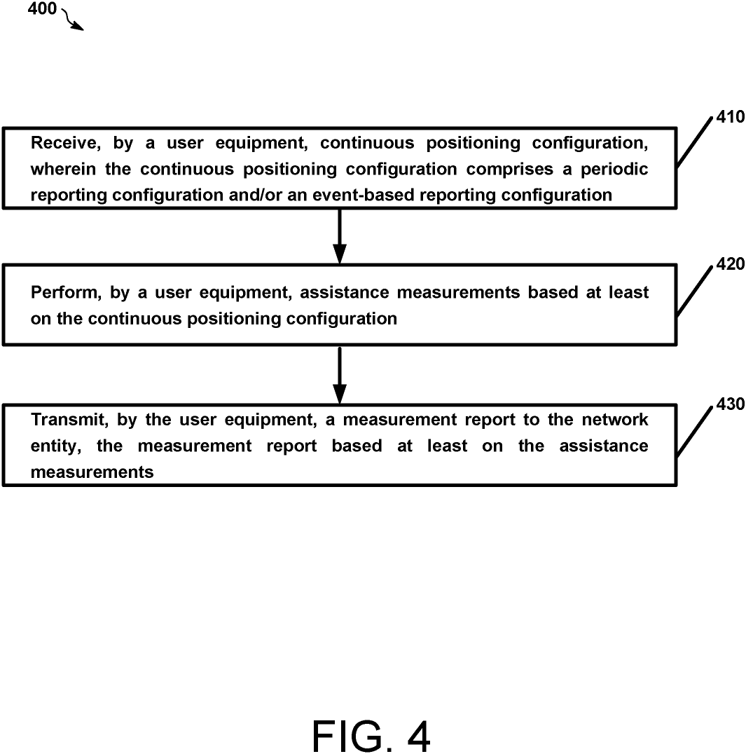

FIG. 4 is a flow chart 400 illustrating dynamic updating of on-demand PRS transmissions, according to an example implementation.

In an example implementation, at block 410, a UE, e.g., UE 202, may receive continuous positioning configuration. In some implementations, for example, the UE may receive continuous positioning configuration which may include periodic reporting configuration and/or event-based reporting configuration from a location server, e.g., LMF 314, for example, as illustrated at 326 of FIG. 3A.

In an example implementation, the UE may receive the continuous positioning configuration from LMF 314 in response to the LMF receiving a periodic location request from the LMF, for example, at 322 of FIG. 3A, or receiving a continuous positioning request from UE 302, for example, as illustrated at 324 of FIG. 3A.

At block 420, the UE may perform assistance measurements based on the continuous positioning configuration. In some implementations, the UE may perform assistance measurements based at least on the continuous positioning configuration received from the LMF. In an example implementation, the UE may perform periodic assistance measurements as indicated in the continuous positioning configuration. In another example implementation, the UE may perform event-based assistance measurements as indicated in the continuous positioning configuration.

At block 430, the UE may transmit a measurement report to the network entity. In some implementations, for example, the UE may transmit a measurement report, which is based at least on the performed assistance measurements, to the network, e.g., LMF 314.

In some implementations, for example, the UE may receive downlink reference signals, which may include PRSs, from network nodes, e.g., gNB 210, 230, and 250. In an example implementation, the UE may receive the PRSs via beams 219, 239, and 255 as illustrated in FIG. 2A. In an additional example implementation, the UE may receive updated PRSs, e.g., PRSs via different beams (or resources), for example, beams 216, 240, and 256, as illustrated in FIG. 2B. The UE may receive the updated PRSs based on the transmission of the assistance measurements to the location server.

Thus, the proposed mechanism describes a UE receiving updated (e.g., dynamically) PRSs based on UE location updates.

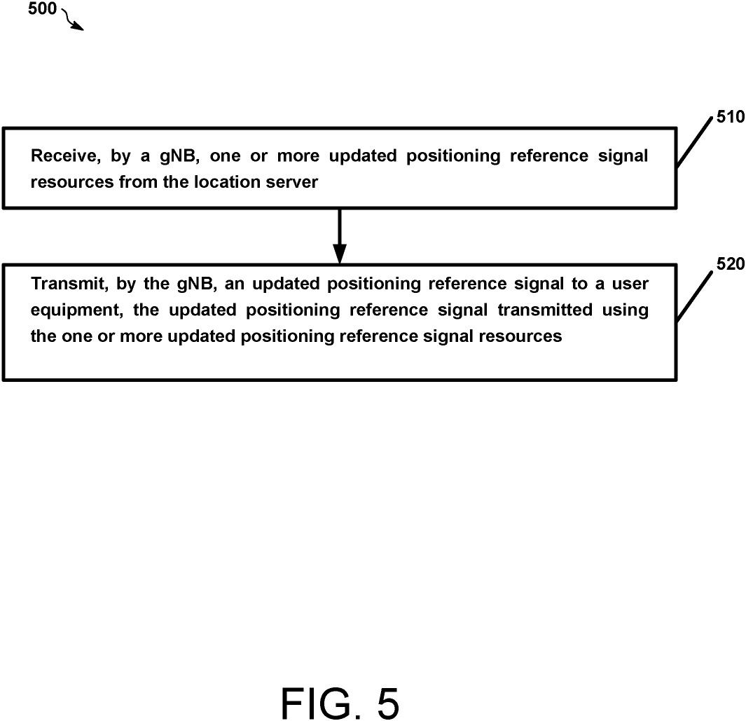

FIG. 5 is a flow chart 500 illustrating dynamic updating of on-demand PRS transmissions, according to an additional example implementation.

In an example implementation, for example, at block 510, a gNB, e.g., gNB 210, may receive one or more updated positioning reference signal resources from a location server, e.g., LMF 314.

At block 520, the gNB may transmit an updated positioning reference signal to a user equipment. In some implementation, the gNB may transmit updated positioning reference signals, as illustrated in FIG. 2B, to a UE, e.g., UE 202.

Thus, the proposed mechanism describes a gNB transmitting updated PRSs to a UE.

Additional example implementations are described herein.

Example 1. A method of communications, comprising: receiving, by a user equipment, continuous positioning configuration, wherein the continuous positioning configuration comprises a periodic reporting configuration and/or an event-based reporting configuration; performing, by a user equipment, assistance measurements based at least on the continuous positioning configuration; and transmitting, by the user equipment, a measurement report to a network entity, the measurement report based at least on the assistance measurements.

Example 2. The method of Example 1, wherein the continuous positioning configuration is received by the user equipment in response to a request initiated by the user equipment or by the network entity.

Example 3. The method of any of Examples 1-2, further comprising: receiving downlink reference signals from one or more network nodes, and wherein the performing further comprises performing the assistance measurements based at least on measuring of the received downlink reference signals.

Example 4. The method of any of Examples 1-3, wherein the downlink reference signals comprise positioning reference signals (PRSs).

Example 5. The method of any of Examples 1-4, wherein the downlink reference signals are received via one or more beams.

Example 6. The method of any of Examples 1-5, further comprising: receiving the downlink reference signals via the one or more beams with updated positioning references signals based at least on the measurement report transmitted from the user equipment.

Example 7. The method of any of Examples 1-6, wherein the assistance measurements comprise one or more of: layer-1 reference signal received power (L1-RSRP) measurements; layer-1 signal-to-interference-plus-noise-ratio (L1-SINR); time of flight; and resource/resource set indices associated with the downlink reference signals.

Example 8. The method of any of Examples 1-7, wherein resource/resource set comprises one or more of: a non-zero power channel state information-reference signal (NZP CSI-RS); a synchronization signal block (SSB); a channel state information-reference signal (CSI-RS); and a positioning reference signal (PRS).

Example 9. The method of any of Examples 1-8, further comprising: configuring the user equipment with the periodic reporting configuration or the event-based reporting configuration based at least on the continuous positioning configuration.

Example 10. The method of any of Examples 1-9, wherein the measurement report is transmitted to the network entity based at least on the periodic reporting configuration or the event-based reporting configuration.

Example 11. The method of any of Examples 1-10, wherein the periodic reporting configuration comprises one or more periodicities.

Example 12. The method of any of Examples 1-11, wherein the periodic reporting configuration comprises a plurality of periodicities, and further comprising: determining whether to switch from a first periodicity to a second periodicity based on whether a periodicity switching condition is satisfied; and switching from the first periodicity to the second periodicity in response to determining that the periodicity condition is satisfied.

Example 13. The method of any of Examples 1-12, wherein the measurement report includes an indication that periodicity switched from the first periodicity to the second periodicity.

Example 14. The method of any of Examples 1-13, further comprising: suspending the transmitting of the measurement report to the network entity.

Example 15. The method of any of Examples 1-14, wherein the suspending is in response to a periodic reporting suspension condition being satisfied, and further comprising: switching from the periodic reporting configuration to the event-based reporting configuration in response to determining that the configuration type switching condition is satisfied.

Example 16. The method of any of Examples 1-15, further comprising: determining whether to switch from the periodic reporting configuration to the event-based reporting configuration based on whether a configuration type switching condition is satisfied; and switching from the periodic reporting configuration to the event-based reporting configuration in response to determining that the configuration type switching condition is satisfied.

Example 17. The method of any of Examples 1-16, determining whether the configuration type switching condition is satisfied comprises: determining that a signal quality of a non-zero power channel state information-reference signal (NZP CSI-RS), a channel state information-reference signal (CSI-RS), or a synchronization signal block (SSB) is below a threshold.

Example 18. The method of any of Examples 1-17, wherein the network nodes comprise gNBs, cells, or transmission reception points (TRPs).

Example 19. The method of any of Examples 1-18, wherein the continuous positioning configuration is received from the network entity, and wherein the network entity comprises a location server.

Example 20. The method of any of Examples 1-19, wherein the location server comprises a location management function (LMF).

Example 21. A method of communications, comprising: receiving, by a gNB, one or more updated positioning reference signal resources from the location server; and transmitting, by the gNB, an updated positioning reference signal to a user equipment, the updated positioning reference signal transmitted using the one or more updated positioning reference signal resources.

Example 22. The method of claim 21, further comprising: transmitting, by the gNB, a beam management update to a location server.

Example 23. A method of communications, comprising: receiving, by a gNB, configuration or an updated configuration based on an identity of at least one new beam detected by a user equipment from a location server; and transmitting, by the gNB, an updated positioning reference signal to the user equipment, the updated positioning reference signal transmitted using the one or more updated positioning reference signal resources.

Example 24. An apparatus comprising means for performing the method of any of Examples 1-23.

Example 25. A non-transitory computer-readable storage medium comprising instructions stored thereon that, when executed by at least one processor, are configured to cause a computing system to perform the method of any of Examples 1-23.

Example 26. An apparatus comprising: at least one processor; and at least one memory including computer program code; the at least one memory and the computer program code configured to, with the at least one processor, cause the apparatus at least to perform the method of any of Examples 1-23.

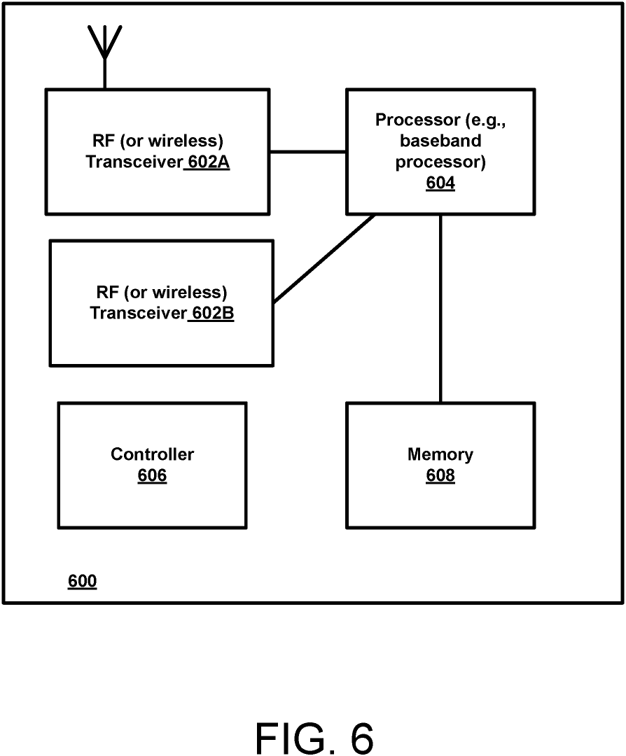

FIG. 6 is a block diagram of a wireless station (e.g., user equipment (UE)/user device or AP/gNB/MgNB/SgNB) 600 according to an example implementation. The wireless station 600 may include, for example, one or more RF (radio frequency) or wireless transceivers 602A, 602B, where each wireless transceiver includes a transmitter to transmit signals and a receiver to receive signals. The wireless station also includes a processor or control unit/entity (controller) 604/606 to execute instructions or software and control transmission and receptions of signals, and a memory 608 to store data and/or instructions.

Processor 604 may also make decisions or determinations, generate frames, packets or messages for transmission, decode received frames or messages for further processing, and other tasks or functions described herein. Processor 604, which may be a baseband processor, for example, may generate messages, packets, frames or other signals for transmission via wireless transceiver 602 (602A or 602B). Processor 604 may control transmission of signals or messages over a wireless network, and may control the reception of signals or messages, etc., via a wireless network (e.g., after being down-converted by wireless transceiver 602, for example). Processor 604 may be programmable and capable of executing software or other instructions stored in memory or on other computer media to perform the various tasks and functions described above, such as one or more of the tasks or methods described above. Processor 604 may be (or may include), for example, hardware, programmable logic, a programmable processor that executes software or firmware, and/or any combination of these. Using other terminology, processor 604 and transceiver 602 together may be considered as a wireless transmitter/receiver system, for example.

In addition, referring to FIG. 6, a controller 606 (or processor 604) may execute software and instructions, and may provide overall control for the station 600, and may provide control for other systems not shown in FIG. 6, such as controlling input/output devices (e.g., display, keypad), and/or may execute software for one or more applications that may be provided on wireless station 600, such as, for example, an email program, audio/video applications, a word processor, a Voice over IP application, or other application or software. Moreover, a storage medium may be provided that includes stored instructions, which when executed by a controller or processor may result in the processor 604, or other controller or processor, performing one or more of the functions or tasks described above.

According to another example implementation, RF or wireless transceiver(s) 602A/602B may receive signals or data and/or transmit or send signals or data. Processor 604 (and possibly transceivers 602A/602B) may control the RF or wireless transceiver 602A or 602B to receive, send, broadcast or transmit signals or data.

The aspects are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input - multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers,...) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer, chip or chipset. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

1. A method of communications, comprising:
receiving, by a user equipment, continuous positioning configuration, wherein the continuous positioning configuration comprises a periodic reporting configuration and/or an event-based reporting configuration;
performing, by a user equipment, assistance measurements based at least on the continuous positioning configuration; and
transmitting, by the user equipment, a measurement report to a network entity, the measurement report based at least on the assistance measurements.

2. The method of claim 1, wherein the continuous positioning configuration is received by the user equipment in response to a request initiated by the user equipment or by the network entity.

3. The method of claim 1, further comprising:
receiving downlink reference signals from one or more network nodes, and
wherein the performing further comprises performing the assistance measurements based at least on measuring of the received downlink reference signals.

4. The method of claim 3, wherein the downlink reference signals comprise positioning reference signals (PRSs).

5. The method of claim 3, wherein the downlink reference signals are received via one or more beams.

6. The method of claim 3, further comprising:
receiving the downlink reference signals via the one or more beams with updated positioning references signals based at least on the measurement report transmitted from the user equipment.

7. The method of claim 3, wherein the assistance measurements comprise one or more of:
layer-1 reference signal received power (L1-RSRP) measurements;
layer-1 signal-to-interference-plus-noise-ratio (L1-SINR);
time of flight; and
resource/resource set indices associated with the downlink reference signals.

8. The method of claim 7, wherein resource/resource set comprises one or more of:
a non-zero power channel state information-reference signal (NZP CSI-RS);
a synchronization signal block (SSB);
a channel state information-reference signal (CSI-RS); and
a positioning reference signal (PRS).

9. The method of claim 1, further comprising:
configuring the user equipment with the periodic reporting configuration or the event-based reporting configuration based at least on the continuous positioning configuration.

10. The method of claim 1, wherein the measurement report is transmitted to the network entity based at least on the periodic reporting configuration or the event-based reporting configuration.

11. The method of claim 1, wherein the periodic reporting configuration comprises one or more periodicities.

12. The method of claim 1, wherein the periodic reporting configuration comprises a plurality of periodicities, and further comprising:
determining whether to switch from a first periodicity to a second periodicity based on whether a periodicity switching condition is satisfied; and
switching from the first periodicity to the second periodicity in response to determining that the periodicity condition is satisfied.

13. The method of claim 1, wherein the measurement report includes an indication that periodicity switched from the first periodicity to the second periodicity.

14. The method of claim 1, further comprising: suspending the transmitting of the measurement report to the network entity.

15. The method of claim 1, wherein the suspending is in response to a periodic reporting suspension condition being satisfied, and further comprising:
switching from the periodic reporting configuration to the event-based reporting configuration in response to determining that the configuration type switching condition is satisfied.

16. The method of any claim 1, further comprising:
determining whether to switch from the periodic reporting configuration to the event-based reporting configuration based on whether a configuration type switching condition is satisfied; and
switching from the periodic reporting configuration to the event-based reporting configuration in response to determining that the configuration type switching condition is satisfied.

17. The method of claim 1, determining whether the configuration type switching condition is satisfied comprises:
determining that a signal quality of a non-zero power channel state information-reference signal (NZP CSI-RS), a channel state information-reference signal (CSI-RS), or a synchronization signal block (SSB) is below a threshold.

18-20. (canceled)

21. A method of communications, comprising:
receiving, by a gNB, one or more updated positioning reference signal resources from the location server; and
transmitting, by the gNB, an updated positioning reference signal to a user equipment,
the updated positioning reference signal transmitted using the one or more updated positioning reference signal resources.

22. The method of claim 21, further comprising:
transmitting, by the gNB, a beam management update to a location server.

23-25. (canceled)

26. An apparatus comprising:
at least one processor; and
at least one memory including computer program code;
the at least one memory and the computer program code configured to, with the at least one processor, cause the apparatus at least to perform the method of claim 1.
